(19) United States
(12) Patent Application Publication
(10) Pub. No.: US 2026/0064438 A1
(43) Pub. Date: Mar. 5, 2026

(54) ELECTRONIC APPARATUS AND METHOD FOR CONTROLLING ELECTRONIC APPARATUS

(71) Applicant: Lenovo (Singapore) Pte. Ltd., Singapore (SG)

(72) Inventors: Yusaku Morishige, Kanagawa (JP); Ken Sasaki, Kanagawa (JP); Kazuo Shiba, Kanagawa (JP); Naoyuki Araki, Kanagawa (JP)

(73) Assignee: Lenovo (Singapore) Pte. Ltd., Singapore (SG)

(21) Appl. No.: 19/313,375

(22) Filed: Aug. 28, 2025

(30) Foreign Application Priority Data
Aug. 29, 2024 (JP) 2024-147806

(51) Int. Cl. G06F 9/445; G06F 21/57

(52) U.S. Cl. CPC G06F 9/44589; G06F 21/575

(57) ABSTRACT

An electronic apparatus includes a processor, a memory that stores a certificate associated with information indicating permission to supply data to an application, for each application, in which the processor, upon system startup, checks whether the certificate for the application running on the system is stored in the memory, and when the certificate for the application is stored in the memory and verification of signature data of the certificate is successful, the processor supplies data to the application.

### CROSS-REFERENCE TO RELATED APPLICATIONS

This application claims priority to Japanese Patent Application No. 2024-147806 filed on Aug. 29, 2024, the contents of which are hereby incorporated herein by reference in their entirety.

### TECHNICAL FIELD

Embodiments of the present invention relate to an electronic apparatus and a method for controlling an electronic apparatus.

### BACKGROUND

In the related art, an electronic apparatus such as a personal computer (PC) executes basic input output system (BIOS) to initialize the electronic apparatus and to start an operating system (OS). In addition, a unified extensible firmware interface (UEFI) BIOS that employs a UEFI defining a software interface between an OS and platform firmware has been developed (for example, see Japanese Unexamined Patent Application Publication No. 2023-116381). In the UEFI BIOS, it is possible to use secure boot to avoid execution of malicious software.

As a method for supplying data from the UEFI BIOS to an application, for example, the following two methods are available.

In a first method, the UEFI BIOS stores data in a serial peripheral interface (SPI) read only memory (ROM) by using SetVariable, and an application acquires the data by using GetVariable. In a second method, the UEFI BIOS installs a protocol for supplying data to an application, and the application acquires the data by locating the protocol.

However, in the first method, when a globally unique identifier (GUID) and a name are known, any application can acquire data by using GetVariable. In addition, in the second method, when the presence of the protocol is known, any application can acquire data by locating the protocol. Therefore, it is necessary to avoid acquisition of secret data by any application.

### SUMMARY

Embodiments of the present invention provide an electronic apparatus and a method for controlling an electronic apparatus capable of safely supplying data to a specific application.

An aspect of the present invention is an electronic apparatus including a processor, and a memory that stores a certificate associated with information indicating permission to supply data to an application, for each application, in which the processor, upon system startup, checks whether the certificate for the application running on the system is stored in the memory, and when the certificate for the application is stored in the memory and verification of signature data of the certificate is successful, the processor supplies data to the application.

In the aspect of the present invention, when the certificate for the application is stored in the memory, the processor may store the data in a storage area accessed by the application.

In the aspect of the present invention, when the certificate for the application is stored in the memory, the processor may install a protocol for supplying the data to the application.

An aspect of the present invention is a method for controlling an electronic apparatus including a processor, and a memory configured to store a certificate associated with information indicating permission to supply data to an application, for each application, the method including a step of checking, upon system startup, whether the certificate for the application running on the system is stored in the memory, and a step of supplying data to the application when the certificate for the application is stored in the memory and verification of signature data of the certificate is successful.

According to an aspect of the present invention, it is possible to safely supply data to a specific application in an electronic apparatus and a method for controlling the electronic apparatus.

### BRIEF DESCRIPTION OF THE DRAWINGS

FIG. 1 is a diagram illustrating a hardware configuration example of an electronic apparatus according to one or more embodiments.

FIG. 2 is a diagram illustrating a functional configuration example of an electronic apparatus according to one or more embodiments.

FIG. 3 is a diagram illustrating an example of a certificate stored in a BIOS database in one or more embodiments.

FIG. 4 is a flowchart illustrating an operation example of the electronic apparatus according to one or more embodiments.

FIG. 5 is a flowchart illustrating an operation example of the electronic apparatus according to one or more embodiments.

### DETAILED DESCRIPTION

Hereinafter, embodiments of the present invention will be described with reference to the drawings.

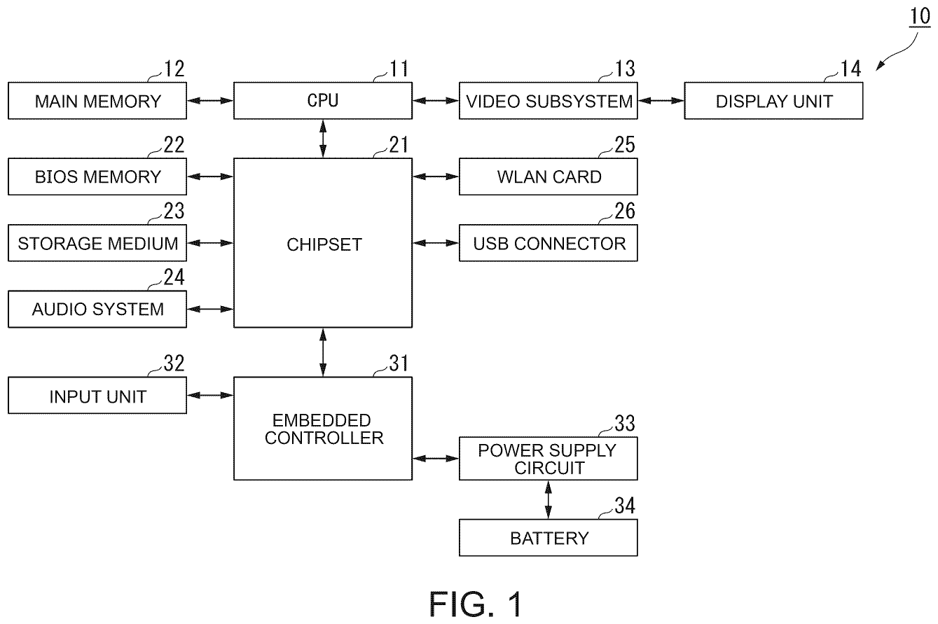

A hardware configuration example of an electronic apparatus 10 according to one or more embodiments will be described with reference to FIG. 1. FIG. 1 is a block diagram illustrating an example of the hardware configuration of the electronic apparatus 10.

The electronic apparatus 10 includes a CPU 11, a main memory 12, a video subsystem 13, a display unit 14, a chipset 21, a BIOS memory 22, a storage medium 23, an audio system 24, a WLAN card 25, a USB connector 26, an embedded controller 31, an input unit 32, a power supply circuit 33, and a battery 34.

The CPU 11 executes various types of arithmetic processing with program control and controls the entire electronic apparatus 10. For example, the CPU 11 executes processing based on programs of an operating system (OS) and a basic input output system (BIOS). The CPU 11 is an example of a processor.

The main memory 12 is a writable memory used as a read area for an execution program of the CPU 11 or as a work area for writing processing data of the execution program. The main memory 12 includes, for example, a plurality of dynamic random access memory (DRAM) chips. This execution program includes an OS, various drivers for operating hardware of peripheral equipment, various services/utilities, an application program, and the like.

The video subsystem 13 is a subsystem for realizing a function related to image display and includes a video controller. The video controller processes a drawing instruction from the CPU 11, writes the processed drawing information to the video memory, reads the drawing information from the video memory, and outputs the drawing information as drawing data (display data) to the display unit 14.

The display unit 14 is, for example, a liquid crystal display or an organic EL display, and displays a display screen based on the drawing data (display data) output from the video subsystem 13.

The chipset 21 includes a controller for a universal serial bus (USB), a serial AT attachment (ATA), a serial peripheral interface (SPI) bus, a peripheral component interconnect (PCI) bus, a PCI-Express bus, low pin count (LPC) bus, and the like, and a plurality of devices are connected to the chipset 21. For example, the BIOS memory 22, the storage medium 23, the audio system 24, the WLAN card 25, the USB connector 26, and the embedded controller 31, which are described later, are included as a plurality of devices.

The BIOS memory 22 includes, for example, an electrically rewritable non-volatile memory such as an electrically erasable programmable read only memory (EEPROM) or a flash ROM. The BIOS memory 22 stores, for example, a BIOS, a system firmware for controlling the embedded controller 31, and the like. The BIOS memory 22 is an example of a sub memory.

The storage medium 23 includes a hard disk drive (HDD), a solid state drive (SSD), and the like. For example, the storage medium 23 stores an OS, various drivers, various services/utilities, an application program, and various data.

A microphone and a speaker (not illustrated) are connected to the audio system 24, and the audio system 24 records, plays, and outputs sound data. The microphone and the speaker are built in the electronic apparatus 10 as an example.

The wireless local area network (WLAN) card 25 is connected to a network by a wireless LAN, and performs data communication. For example, when the WLAN card 25 receives data from the network, the WLAN card 25 generates an event trigger indicating that the data has been received. The USB connector 26 is a connector for connecting peripheral equipment using USB.

The input unit 32 collectively indicates input devices (input equipment) included in the electronic apparatus 10. The input unit 32 includes a keyboard, a mouse, and the like. The input unit 32 outputs input information input by a user's operation to the embedded controller 31.

The power supply circuit 33 includes, for example, a DC/DC converter, a charge/discharge unit, an AC/DC adapter, and the like. For example, the power supply circuit 33 converts a DC voltage supplied from an external power supply such as an AC adapter (not illustrated) or the battery 34 into a plurality of voltages required for operating the electronic apparatus 10. In addition, the power supply circuit 33 supplies electric power to each unit of the electronic apparatus 10 based on the control from the embedded controller 31.

The battery 34 is a secondary battery such as a lithium-ion battery, for example. When electric power is supplied to the electronic apparatus 10 from an external power supply, the battery 34 is charged via the power supply circuit 33. When electric power is not supplied to the electronic apparatus 10 from an external power supply, the battery 34 outputs the accumulated electric power as operating power of the electronic apparatus 10 via the power supply circuit 33.

The embedded controller 31 is a one-chip microcomputer that monitors and controls various devices (peripheral devices, sensors, and the like) regardless of a state of a system of the electronic apparatus 10. The embedded controller 31 includes a CPU, a ROM, a RAM, a plurality of channels of A/D input terminals and a D/A output terminal, a timer, and a digital input/output terminal, which are not illustrated. The input unit 32, the power supply circuit 33, and the like are connected to the digital input/output terminal of the embedded controller 31, and the embedded controller 31 controls operations thereof. In addition, the embedded controller 31 performs control such as a change in clock frequency of the CPU 11 via the chipset 21.

In the electronic apparatus 10, a display device may be integrally attached to a chassis as in a portable device such as a clamshell type personal computer, a tablet terminal, or a smartphone. Alternatively, in the electronic apparatus 10, the apparatus main body and the display device may be separated from each other as in a desktop personal computer. The electronic apparatus 10 according to one or more embodiments is applicable to all apparatuses including a CPU.

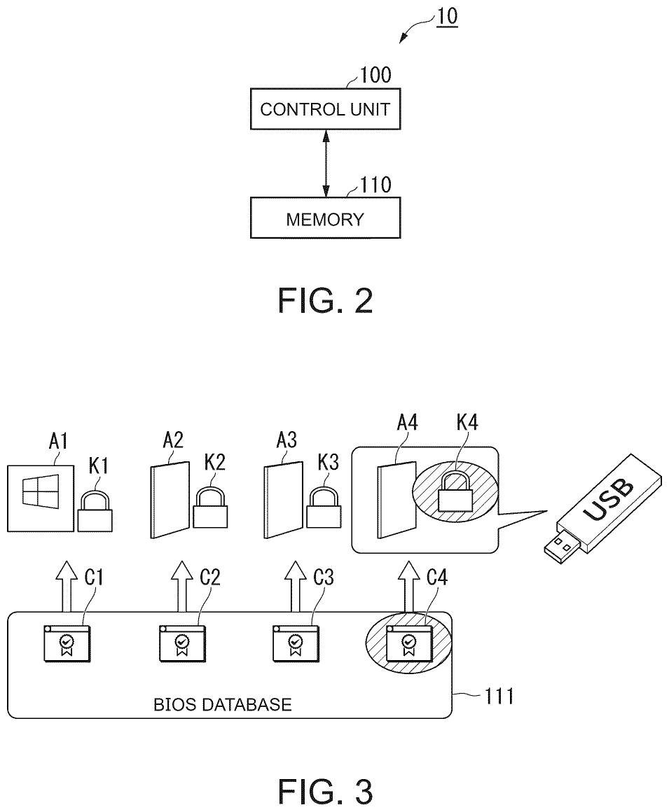

A functional configuration example of the electronic apparatus 10 will be described with reference to FIG. 2. FIG. 2 is a block diagram illustrating an example of a functional configuration of the electronic apparatus 10 related to the UEFI BIOS.

The electronic apparatus 10 includes a control unit 100 and a memory 110. The control unit 100 is an example of a processor. The functions of the control unit 100 are realized by the CPU 11, the embedded controller 31, or a combination of the CPU 11 and the embedded controller 31.

The memory 110 stores a program of the control unit 100, data used by the control unit 100, data generated by the control unit 100, and the like. The functions of the memory 110 are realized by the main memory 12, the BIOS memory 22, or a combination of the main memory 12 and the BIOS memory 22.

The control unit 100 loads the application with LoadImage of UEFI and transfers the control to the application with StartImage. The control unit 100 manages the certificate used for the secure boot for each application.

FIG. 3 illustrates an example of a certificate stored in a BIOS database 111 in the memory 110. The BIOS database 111 stores certificates C1 to C4. The certificates C1 to C4 are certificates issued to applications A1 to A4, respectively. The certificates C1 to C4 each include signature data signed by secure boot keys K1 to K4. A user having administrator permission can add or delete a certificate.

When the supply of data to the application A4 is permitted, the information indicating that the supply of the data to the application A4 is permitted and the certificate C4 of the application A4 are associated with each other. The information is stored in the BIOS database 111. The information may be included in the certificate C4. When the information indicating the permission of the supply of data is separated from the certificate C4, it is not necessary to change a certificate of secure boot, and the certificate C4 can be configured in the same manner as the certificates C1 to C3.

The control unit 100 executes power-on self-test (POST) when the system of the electronic apparatus 10 is started. In this case, the control unit 100 verifies the signature data of the certificates C1 to C4. When the verification of the signature data is successful, the control unit 100 permits the start of the applications A1 to A4. In addition, since the information indicating the permission of the supply of secret data is associated with the certificate C4, the control unit 100 permits the supply of the secret data to the application A4.

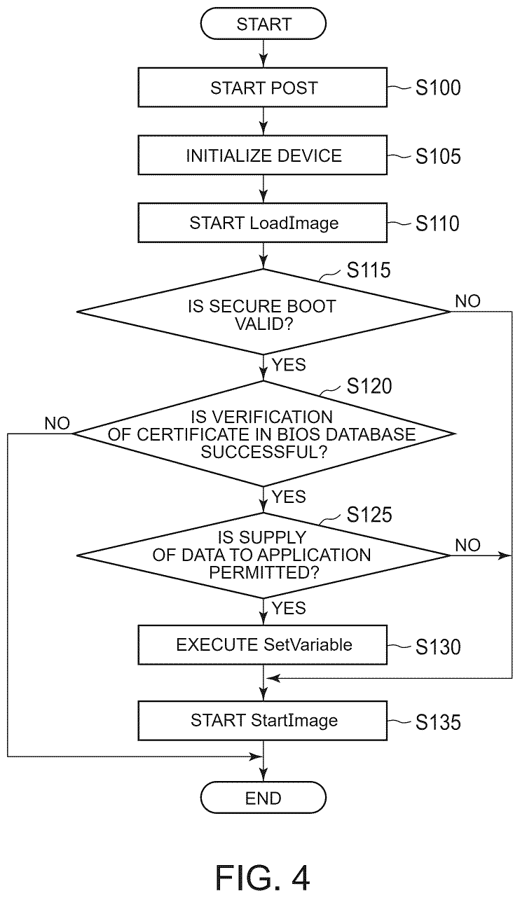

Processing executed by the electronic apparatus 10 will be described with reference to FIG. 4. FIG. 4 is a flowchart illustrating the operation example of the electronic apparatus 10.

### (Step S100)

When the power of the electronic apparatus 10 is turned on and the system of the electronic apparatus 10 is started, the control unit 100 starts POST.

### (Step S105)

The control unit 100 initializes each device included in the electronic apparatus 10.

### (Step S110)

The control unit 100 starts LoadImage in a preset boot order.

### (Step S115)

The processing is branched according to the setting of the secure boot. When the setting of the secure boot is valid, step S120 described below is executed. When the setting of the secure boot is not valid, step S135 described below is executed.

### (Step S120)

When the setting of the secure boot is valid, the control unit 100 acquires the name of the application from LoadImage, and verifies the signature data of the certificate stored in the BIOS database of the memory 110 for the application. When the verification of the signature data is successful, step S125 described below is executed. When the verification of the signature data fails, the start of the application is stopped.

### (Step S125)

When the verification of the signature data is successful in step S120, the control unit 100 checks whether the information indicating the permission of the supply of the data is associated with the certificate. When the information is associated with the certificate, the supply of the data to the application is permitted, and step S130 described below is executed. When the information is not associated with the certificate, the supply of the data to the application is not permitted, and step S135 described below is executed.

### (Step S130)

When the information indicating the permission of the supply of the data is associated with the certificate, the control unit 100 executes SetVariable without attaching an EFI VARIABLE NON VOLATILE attribute. By not attaching this attribute, there is a security advantage that the data is not stored in the SPI ROM but in a volatile memory, and thus the data does not remain in the next Boot.

### (Step S135)

The control unit 100 executes the StartImage to start the application.

In the operation example illustrated in FIG. 4, the control unit 100 stores the data in the volatile memory by executing SetVariable, and the application acquires the data from the volatile memory by executing GetVariable.

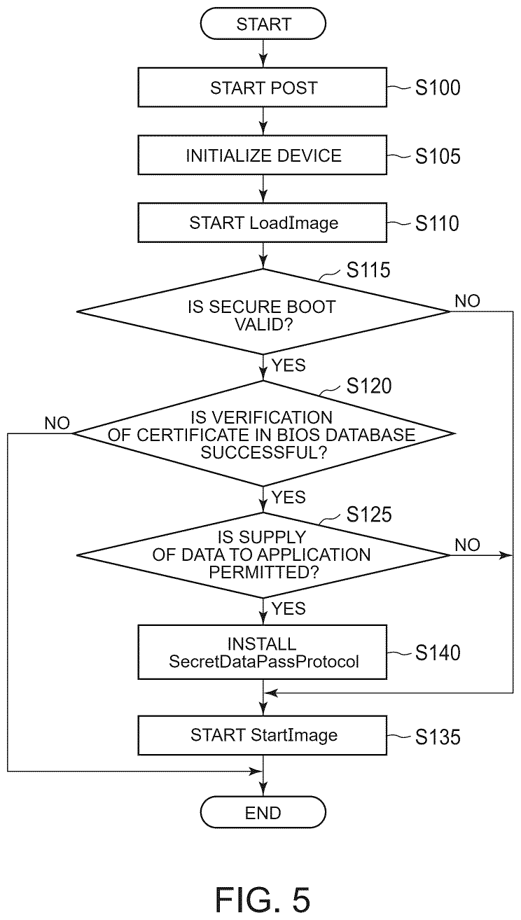

FIG. 5 is a flowchart illustrating another operation example of the electronic apparatus 10. The description of the same processing as the processing illustrated in FIG. 4 will be omitted. Instead of step S130 illustrated in FIG. 4, step S140 described below is executed.

### (Step S140)

When the information indicating the permission of the supply of the data is associated with the certificate, the control unit 100 installs a protocol (SecretDataPassProtocol) for supplying the data to the application.

In the operation example illustrated in FIG. 5, the control unit 100 installs the protocol, and the application acquires the data by locating the protocol.

As described above, the memory 110 stores the certificate associated with the information indicating the permission to supply the data to the application for each application. Upon system startup, the control unit 100 checks whether a certificate for an application running on the system is stored in the memory 110. When the certificate for the application is stored in the memory 110 and the verification of the signature data of the certificate is successful, data is supplied to the application. Accordingly, the electronic apparatus 10 can safely supply data to a specific application.

When the certificate for the application is stored in the memory 110, the control unit 100 stores data in a storage area accessed by the application. In the above example, the control unit 100 can safely supply data to the application by executing SetVariable.

When the certificate for the application is stored in the memory 110, the control unit 100 installs a protocol for supplying data to the application. In the above example, the control unit 100 can safely supply data to the application by installing a SecretDataPassProtocol.

Although one or more embodiments of the present invention has been described in detail with reference to the drawings above, a specific configuration is not limited to the above-described embodiments, and includes design changes and the like within a range not deviating from the gist of the present invention.

### DESCRIPTION OF SYMBOLS

10 electronic apparatus
11 CPU
12 main memory
13 video subsystem
14 display unit
21 chipset
22 BIOS memory
23 storage medium
24 audio system
25 WLAN card
26 USB connector
31 embedded controller
32 input unit
33 power supply circuit
34 battery
35 switch
100 control unit
110 memory

What is claimed is:

1. An electronic apparatus comprising:
a processor; and
a memory configured to store a certificate associated with information indicating permission to supply data to an application, for each application, wherein
the processor, upon system startup, checks whether the certificate for the application running on the system is stored in the memory, and
when the certificate for the application is stored in the memory and verification of signature data of the certificate is successful, the processor supplies data to the application.

2. The electronic apparatus according to claim 1, wherein
when the certificate for the application is stored in the memory, the processor stores the data in a storage area accessed by the application.

3. The electronic apparatus according to claim 1, wherein
when the certificate for the application is stored in the memory, the processor installs a protocol for supplying the data to the application.

4. A method for controlling an electronic apparatus including
a processor, and
a memory configured to store a certificate associated with information indicating permission to supply data to an application, for each application, the method comprising:
a step of checking, upon system startup, whether the certificate for the application running on the system is stored in the memory; and
a step of supplying data to the application when the certificate for the application is stored in the memory and verification of signature data of the certificate is successful.
